(19) United States
(12) Patent Application Publication
(10) Pub. No.: US 2006/0018522 A1
(43) Pub. Date: Jan. 26, 2006

(54) System and method applying image-based face recognition for online profile browsing

(75) Inventors: Jeffery Jon Sunzeri, San Jose, CA (US); Sugiharto Widjaja, San Mateo, CA (US)

Correspondence Address: BIRCH STEWART KOLASCH & BIRCH, PO BOX 747, FALLS CHURCH, VA, 22040-0747, US

(73) Assignee: FUJIFILM Software(California), Inc., San Jose, CA (US)

(21) Appl. No.: 11/150,248

(22) Filed: Jun. 13, 2005

Related U.S. Application Data
(60) Provisional application No. 60/578,871, filed on Jun. 14, 2004.

(51) Int. Cl. G06K 9/00

(52) U.S. Cl. 382/118

(57) ABSTRACT

A computer-implemented method provides an online dating service in which users browse profiles of other participants using face recognition. The method comprises: inputting a model image including a face of a person, the model image representing a profile browsing preference for a user; accessing a plurality of profile images, the profile images corresponding to different participants of the online dating service; performing face recognition to determine similarity of the model image to the plurality of profile images, thereby identifying profile images that resemble the model image; outputting a display view showing a result of the face recognition, the display view including at least one profile image resembling the model image; and providing additional profile information associated with a profile image in the display view based on input browsing commands.

### RELATED APPLICATION

The present application claims the benefit of Provisional Patent Application No. 60/578,871 filed Jun. 14, 2004, the entirety of which is incorporated herein by reference.

### FIELD OF THE INVENTION

The present invention relates to online profile browsing, and more particularly to a system and method for applying image-based face recognition to online profile browsing.

### BACKGROUND OF THE INVENTION

Just as technological advances, including word-processing and desktop publishing programs, email, video conferencing systems, corporate intranets, etc., have enhanced productivity and work quality of businesses, communications technology, in particular the Internet and mobile phone services, has significantly influenced the social lives of individuals. Computer networks, such as the Internet/World Wide Web, enable users to communicate via email, instant messaging, and electronic forums as well as access an almost unlimited amount of information and online services.

As an example of how the Internet has become an integral part of modern culture, it is estimated that millions of users visit online dating sites annually in the U.S., with most of these users posting their personal profiles online and many subscribing to fee-based online dating services. Such fee-based online dating services currently generate a significant amount of revenue, which is expected to increase in coming years. More recently, online dating services have been integrated with Instant Messaging, and such services likely will become increasingly accessible by cellular phone users.

The current methodology for searching through user profiles for potentially compatible participants is based on criteria such gender, age, location, interests, and demographics. The time required to browse through candidate profiles using this typical methodology is often time-consuming and unproductive, making it difficult for users to find candidates to which they would likely be compatible and physically attracted. As a result, it is often difficult for service providers to keep participants engaged in the process. Furthermore, although current online dating services allow users to post their own images, these images typically need to be cropped, re-sized, and enhanced before uploading, which is often a tedious and lengthy process.

### SUMMARY

According to one aspect of the present invention, a computer-implemented method provides an online dating service in which users browse profiles of other participants using face recognition. The method comprises: inputting a model image including a face of a person, the model image representing a profile browsing preference for a user; accessing a plurality of profile images, the profile images corresponding to different participants of the online dating service; performing face recognition to determine similarity of the model image to the plurality of profile images, thereby identifying profile images that resemble the model image; outputting a display view showing a result of the face recognition, the display view including at least one profile image resembling the model image; and providing additional profile information associated with a profile image in the display view based on input browsing commands.

According to another aspect of the present invention, an apparatus provides online dating services in which users browse profiles of other participants using face recognition. The apparatus comprises: a model image input for inputting a model image including a face of a person, the model image representing a profile browsing preference for a user; a database storing a plurality of participant profiles each associated with a profile image, the profile images corresponding to different participants of the online dating service; a face recognition unit accessing a plurality of profile images from the database and performing face recognition to determine similarity of the model image to the plurality of profile images, thereby identifying profile images that resemble the model image; a display view output for outputting a display view showing a result of the face recognition, the display view including at least one profile image resembling the model image; and a profile data output providing additional profile information associated with a profile image in the display view based on input browsing commands.

### BRIEF DESCRIPTION OF THE DRAWINGS

Additional aspects of the present invention will become apparent upon reading the following detailed description, taken in conjunction with the accompanying drawings, in which:

FIG. 1 illustrates an exemplary communications network environment to which principles of the present invention may be applied to enhance online profile browsing;

FIG. 2 is a block diagram illustrating elements of an apparatus for performing face recognition-based searching in an online profile browsing service in accordance with an embodiment of the present invention;

FIG. 3 is a flow diagram illustrating operations performed during an image match process for profile browsing in accordance with an embodiment of the present invention;

FIG. 4 is a flow diagram illustrating operations performed during profile set up in accordance with an embodiment of the present invention;

FIG. 5 shows an exemplary source image to be processed in accordance with principles of the present invention to derive a model image for matching with stored profile images; and

FIG. 6 shows an exemplary display view of sorted profile images based on comparison to a model image in accordance with an exemplary implementation of the present invention.

### DETAILED DESCRIPTION

Embodiments of the present invention described below address drawbacks of typical online dating services by applying image processing techniques to enable more intelligent browsing of candidate profiles and to make it easier for users to post quality images to be associated with their profiles during set up. By applying principles of the present invention, service providers can improve the quality of, and increase subscriber numbers and revenue generated by, their online dating sites. Aspects of embodiments of the present invention are specifically set forth in the following description with reference to the appended Figures.

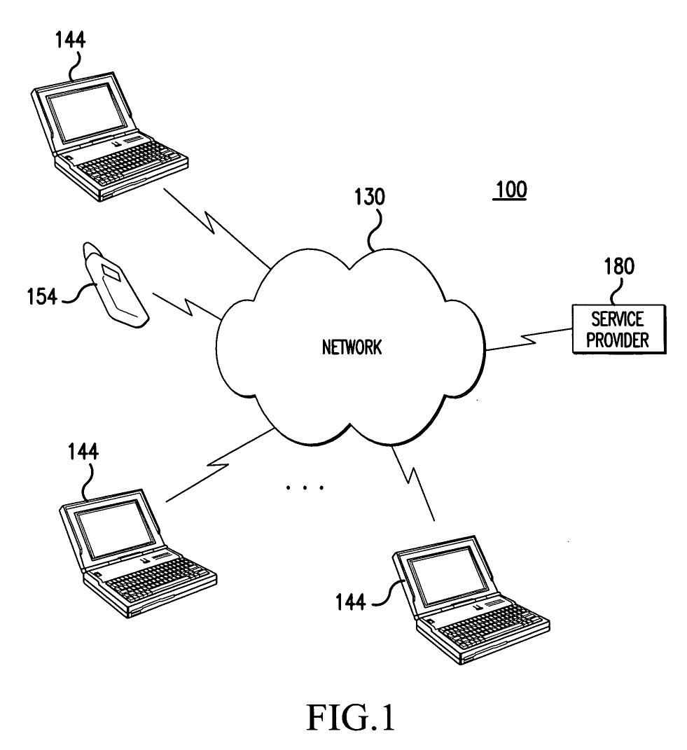

FIG. 1 illustrates an exemplary communications network environment to which principles of the present invention may be applied to enhance online profile browsing according to an embodiment of the present invention. As shown, the communications network 100 includes: a data network 130, such as the Internet; a service provider 180, e.g., a server hosting an online dating site; and a plurality of users connected to the service provider 180 via the data network 130. As shown in FIG. 1, the users may connect to the communications network 100 via computer (e.g., laptop or desktop) 144, executing web browser software. It should be recognized, however, that principles of the present invention are not limited to such an environment and may also be applied to users of cellular phones 154 or other mobile devices (e.g., personal digital assistants) connected to the service provider 180 via the data network 130.

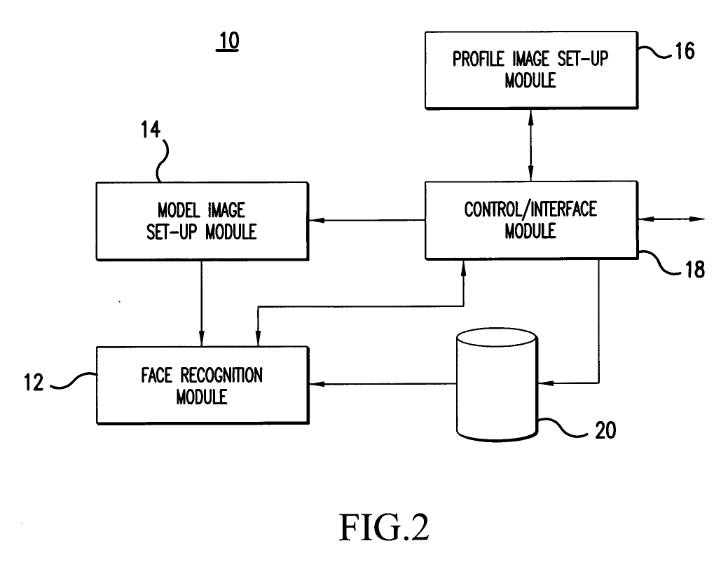

FIG. 2 is a block diagram illustrating elements of an apparatus for performing face recognition-based profile browsing in accordance with an embodiment of the present invention. As shown in FIG. 2, the profile matching apparatus 10 includes: a face recognition module 12; a model image set-up module 14; a profile image set-up module 16; a control/interface module 18; and a profile database 20. Although the apparatus of FIG. 2 is illustrated as containing multiple discrete elements, it should be recognized that this illustration is for ease of explanation and that the operations described herein may be performed in one or more physical devices (e.g., using hardware-software combination(s)). The profile matching apparatus 10 of this embodiment may be implemented using a software package executed by a computer of the service provider 180, connected to the data network 130. It should be recognized, however, that functions associated with embodiments of the present invention may be distributed between the service provider 180 and software executed by the user end (e.g., computer 144).

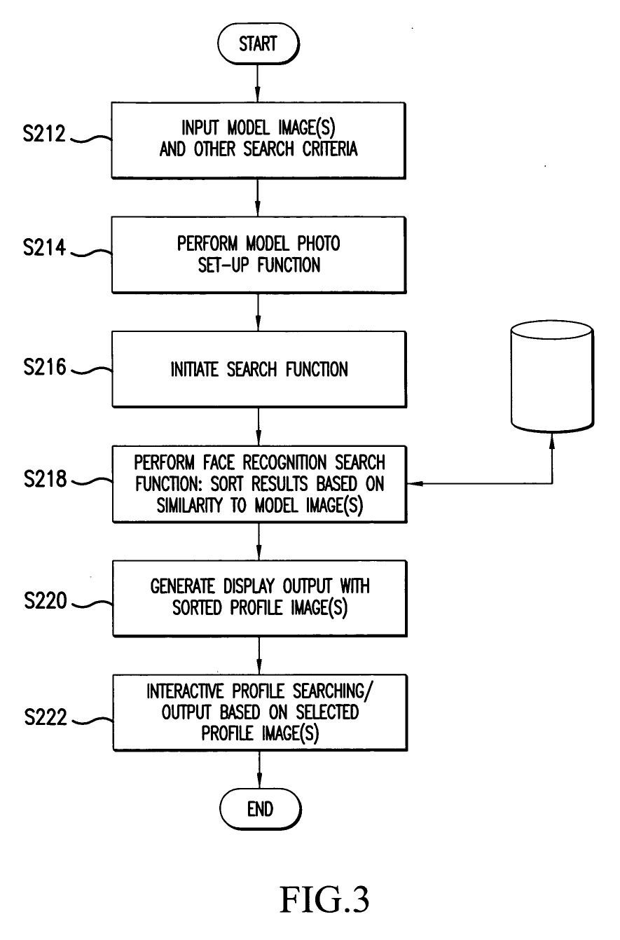

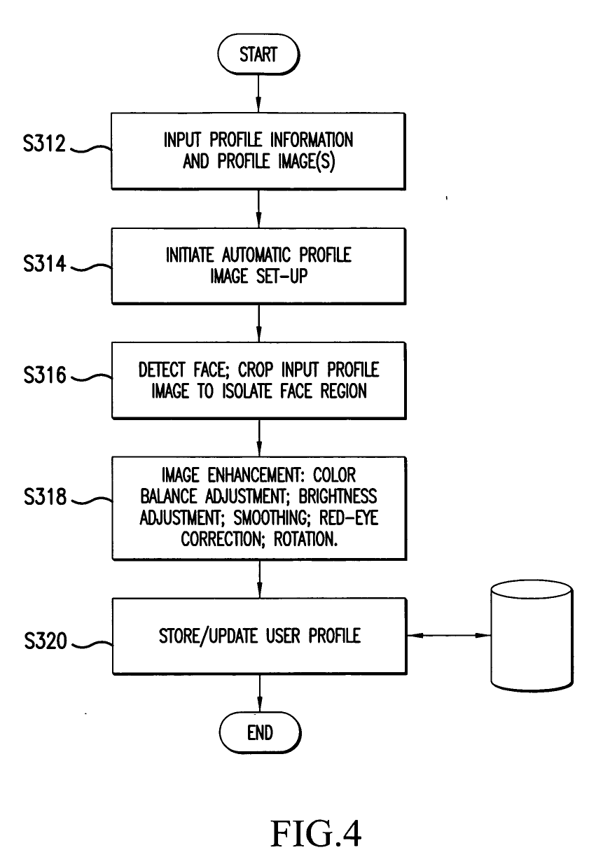

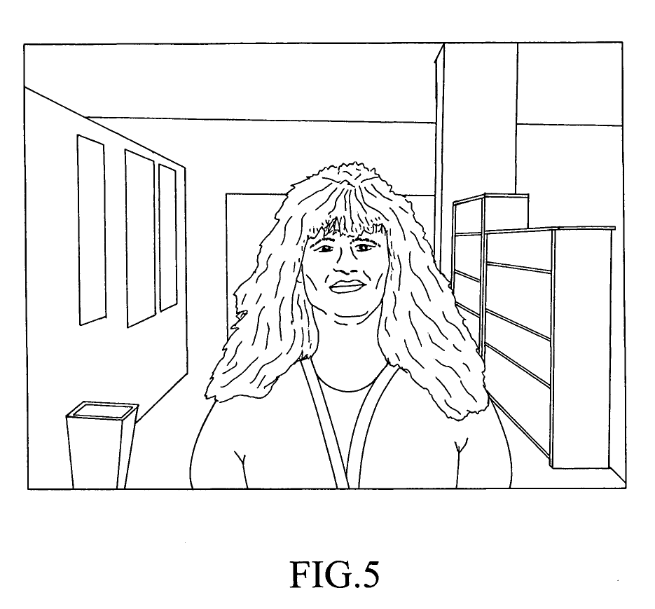

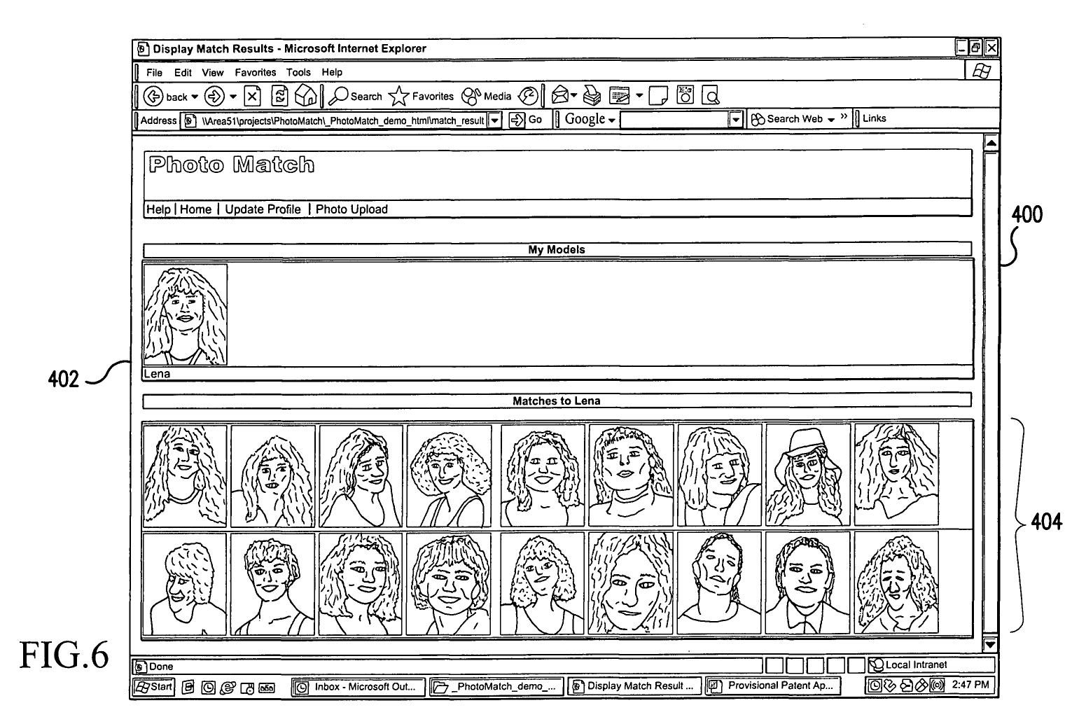

The operations performed by the profile matching apparatus 10 will next be described with reference to the flow diagrams of FIGS. 3 and 4, the example input model image of FIG. 5, and the example display view of sorted matches of FIG. 6. Generally, an embodiment of the present invention permits a user to establish one or more digitized photographs of people as a model, and search a repository of photographs of participants of an online dating service. Repository face images are sorted based on similarity to the model image(s), thereby allowing the user to quickly browse through participant profiles based, at least in part, on appearance preferences.

An embodiment of the present invention includes two phases of operation: model setup; and model matching. Initially, the control/interface module 18 receives one or more model images from a user (e.g., an end user's computer 144 executing web browser software) via the network 130 (S212). An example input model image is shown in FIG. 5. The input model image(s) may have a variety of file types, including: Tiff; BMP; JPEG; GIF. The end user is prompted to identify the image(s) to be used as a model image. After uploading/storing the user-selected model image(s), the control/interface module 18 transfers the model image(s) to the model image set-up module 14, which executes model image set up (S214). More specifically, the model image set-up module 14 detects any faces in the model image(s), and produces a cropped (and re-oriented if necessary) image of each individual in the image(s). The model image set-up module 14 may detect and crop/re-size faces using techniques described in S. Ioffe, “Red Eye Detection With Machine Learning,” In Proceedings of Int. Conf. On Image Processing (ICIP), 2003, which is incorporated herein by reference.

After model image set-up is complete, the control/interface module 18 initiates a repository search function (S216) when the user requests a search to find people that resemble the person/people in the model image(s). The repository (database) 20 stores profile images that have previously been processed (e.g., cropped, re-oriented, enhanced) by the profile image set-up module 16. The face recognition module 12 accesses profile images form the database 20 and performs face recognition to determine similarity to the model image(s) (S218). The face recognition module 12 sorts the profile images based on a similarity score.

The face recognition module 12 can apply various image matching techniques to determine similarity between the model image(s) and profile images retrieved from the database 20. In one implementation, the face recognition module 12 performs face recognition with reference faces (profile images) using calculated feature values as in U.S. patent application Ser. No. 10/734,258 filed Dec. 15, 2003, titled “Method and Apparatus for Object Recognition Using Probability Models,” which is incorporated herein by reference.

The control/interface module 18 generates a display view with the sorted profile images (S220) for display to the user. FIG. 6 shows an exemplary display view of sorted matches to the model image(s) in accordance with an implementation of the present invention. The display view 400 in this implementation includes a model image display region 402, which displays the processed model image(s), and a sorting result display region 404, which displays profile images sorted by similarity to the model image(s). Using this tool, the user is able to save time by browsing through profiles based on physical appearance. For example, the user may click on any of the images in the sorting result display region 404 to access additional profile information (S222), stored in database 20. Furthermore, the profile images to be sorted using face recognition may be pre-filtered based on other criteria input by the user, such as age, interests, and geographic location. Such pre-filtering can significantly decrease the processing load for the face recognition module 12.

Another aspect of the present invention enables users to easily post profile images for online dating services and improve the quality of such images before posting. This aspect of the present invention will be described with reference to the flow diagram of FIG. 4. In an exemplary online dating system, each member digitally registers a membership and inputs their profile, which will typically include at least one photo. Profiles of other members/participants are stored in the database 20 and can be selectively accessed by other members/participants (or the administrator) by specifying criteria, such as age, gender, interests, location, etc. The process for generating the database of profiles in accordance with one embodiment of the present invention is a described below.

A registered member inputs his/her profile information, including their picture or pictures, to the system (S312). In the case of multiple people in the picture, a specific face in the picture may be selected. Upon registration, the control/interface module 18 initiates an automatic profile image set-up process (S314). During automatic profile image set-up, the profile image set-up module 16 detects a face or faces in the input profile image and crops out (and re-orients if necessary) the face region (S316). This allows the final profile image to adequately reflect the member's facial appearance. The profile image set-up module 16 next performs image enhancement (S318), which may include color balance and brightness adjustment, smoothing the skin region of the image, and correcting the red eye(s) by using automatic red eye correction, such as described in S. Ioffe, “Red Eye Detection With Machine Learning,” In Proceedings of Int. Conf. On Image Processing (ICIP), 2003, which is incorporated herein by reference.

Because the image processing operations are performed automatically, the profile image set-up procedure is made easy for the user. For example, after providing original image(s) that the user wishes to post in their profile, the user may simply click on a “1-click setup” prompt, which causes the control/interface module 18 to initiate the automatic cropping/image enhancement processing operations performed by the profile image set-up module 16. The processed profile image(s) and other entered profile information is stored in the database 20 for future access by other members/participants (S320).

When the user wants to find a person or persons whom he/she would consider dating, he/she can specify other criteria, including age, location, interests, etc. Sometimes, the user will not specify any criteria so that they can search all candidates. The result of the search, however, tends to be large, so the user will often refine the search to a smaller number of candidates based on various criteria.

As described above, the user can specify the picture of a face (model image) so that he/she can find the members/online dating candidates having similar faces to the one specified. This operation can either eliminate the candidate images that fall below a threshold similarity measure (i.e., are not similar to the model) or display all candidate images in the order of similarity, as shown in the example of FIG. 6. The user can register multiple model images in his/her profile so that they can easily specify a different face when searching for members with similar faces. The image file of the model picture does not have to be in the database (e.g., only the image data, or feature values, associated with the face can be stored).

Although the user may upload the model image(s) in the manner described above, it is also possible for the system to provide predetermined faces (e.g., images of famous people), thus allowing the user to merely select a face to be used as the model image for comparison with the repository images of the database 20 associated with online dating candidates.

Embodiments of the invention having been thus described, it should be apparent that such embodiments may be varied without departing from the scope of the claims set forth below.

We claim:

1. A computer-implemented method for providing an online dating service in which users browse profiles of other participants, said method comprising:
inputting a model image including a face of a person, said model image representing a profile browsing preference for a user;
accessing a plurality of profile images, said profile images corresponding to different participants of said online dating service;
performing face recognition to determine similarity of said model image to said plurality of profile images, thereby identifying profile images that resemble said model image;
outputting a display view showing a result of said face recognition, said display view including at least one profile image resembling said model image; and
providing additional profile information associated with a profile image in said display view based on input browsing commands.

2. The method according to claim 1, wherein said method further comprises:
detecting a face region in said input model image and cropping the detected face region, thereby obtaining a model image for subsequent face recognition.

3. The method according claim 1, wherein a plurality of model images are input.

4. The method according to claim 3, wherein a user selects one of said model images as a profile browsing preference.

5. The method according to claim 1, wherein said input model image is selected from a catalogue of model images.

6. The method according to claim 1, wherein said input model image is a digitized photograph provided by a user via a data network.

7. The method according to claim 1, wherein said display view includes a plurality of profile images, sorted based on similarity to said model image.

8. The method according to claim 7, wherein said providing step provides additional profile information associated with a profile image in said display view interactively selected by a user.

9. The method according to claim 1, further comprising:
inputting profile browsing criteria,
wherein said plurality of profile images are accessed based on said input profile browsing criteria.

10. The method according to claim 9, wherein said profile browsing criteria include at least one of age, gender, location, or interests.

11. The method according to claim 1, further comprising:
generating a profile for a user by receiving a profile image for a user, enhancing said profile image, and storing said profile image with profile information for said user.

12. The method according to claim 11, wherein profile image is enhanced by:
detecting a face region in the profile image;
cropping the profile image to isolate the detected face region; and
smoothing the detected face region in said profile image.

13. The method according to claim 12, wherein said profile image is further enhanced by automatically adjusting brightness and color balance characteristics of said profile image.

14. The method according to claim 11, wherein said profile image is automatically enhanced upon input by a user.

15. An apparatus for providing an online dating service in which users browse profiles of other participants, said apparatus comprising:
a model image input for inputting a model image including a face of a person, said model image representing a profile browsing preference for a user;
a database storing a plurality of participant profiles each associated with a profile image, said profile images corresponding to different participants of said online dating service;
a face recognition unit accessing a plurality of profile images from said database and performing face recognition to determine similarity of said model image to said plurality of profile images, thereby identifying profile images that resemble said model image;
a display view output for outputting a display view showing a result of said face recognition, said display view including at least one profile image resembling said model image; and
a profile data output providing additional profile information associated with a profile image in said display view based on input browsing commands.

16. The apparatus according to claim 15, further comprising:
a model image set-up unit for detecting a face region in said input model image and cropping the detected face region, thereby obtaining a model image used for subsequent face recognition.

17. The apparatus according claim 15, wherein said model image input inputs a plurality of model images.

18. The apparatus according to claim 17, wherein a user selects one of said model images as a profile browsing preference.

19. The apparatus according to claim 15, wherein said input model image is selected from a catalogue of model images.

20. The apparatus according to claim 15, wherein said input model image is a digitized photograph provided by a user via a data network.

21. The apparatus according to claim 15, wherein said display view includes a plurality of profile images, sorted based on similarity to said model image.

22. The apparatus according to claim 21, wherein said profile data output provides profile information associated with a profile image in said display view interactively selected by a user.

23. The apparatus according to claim 15, further comprising:
a profile browsing criteria input,
wherein said face recognition unit accesses profile images from said database based on said input profile browsing criteria.

24. The apparatus method according to claim 23, wherein said profile browsing criteria include at least one of age, gender, location, or interests.

25. The apparatus according to claim 15, further comprising:
a profile image set-up unit for receiving a profile image for a user and enhancing said profile image, wherein said profile image is stored with profile information for said user in said database.

26. The apparatus according to claim 25, wherein said profile image set-up unit enhances said profile image by: detecting a face region in the profile image; cropping the profile image to isolate the detected face region; and smoothing the detected face region in said profile image.

27. The apparatus according to claim 26, wherein said profile image set-up unit further enhances said profile image by automatically adjusting brightness and color balance characteristics of said profile image.

28. The apparatus according to claim 25, wherein said profile image set-up unit automatically enhances said profile image upon input by a user.
